(19) United States
(12) Patent Application Publication
(10) Pub. No.: US 2006/0166128 A1
(43) Pub. Date: Jul. 27, 2006

(54) Lithographic materials based on polymers containing polyhedral oligomeric silsesquioxanes

(75) Inventors: Evangelos Gogolides, Athens (GR); Panagiotis Argitis, Athens (GR); Vasilios Bellas, Athens (GR); Evangelia Tegou, Athens (GR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: NCSR Demokritos, Athens (GR)

(21) Appl. No.: 10/516,384

(22) PCT Filed: May 30, 2003
(86) PCT No.: PCT/GR03/00018

§ 371 Date: Jul. 5, 2005

(30) Foreign Application Priority Data
Nov. 30, 2004 (GR) 20020100253

(51) Int. Cl. G03C 1/76

(52) U.S. Cl. 430/270.1

(57) ABSTRACT

Materials are described suitable for optical lithography in the ultraviolet region (including 157 nm and extreme ultraviolet region), and for electron beam lithography. These materials are based on new homopolymers and copolymers, they are characterized by the presence of polyhedral oligomeric silsequioxanes in their molecule, and they are suitable for single as well as bilayer lithography. Ethyl, or similar or smaller size, groups are used as alkyl substituents of the silsequioxanes in order to reduce problems related to pattern transfer, roughness, and high absorbance at 157 nm (such problems occur when the substituents are large alkyl groups such as cyclopentyl groups).

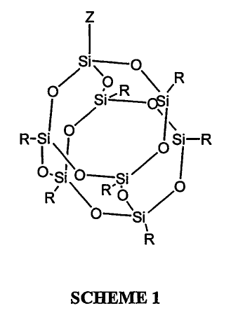

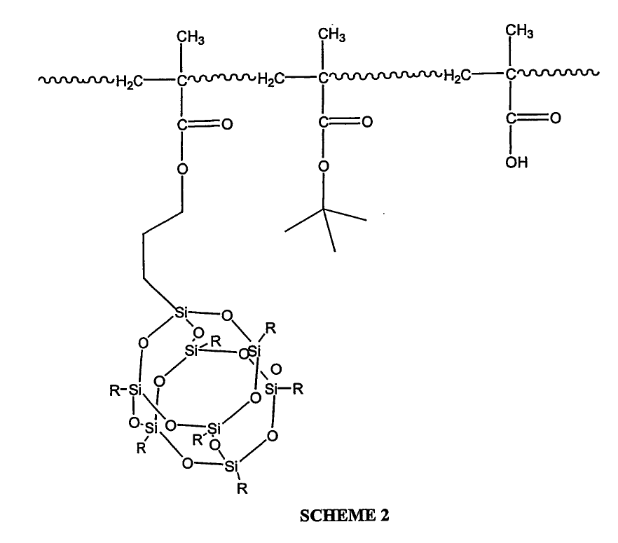

This invention concerns new materials for optical lithography at the ultraviolet region, including 157 nm and the extreme ultraviolet region, and for electron beam lithography. New polymeric lithographic materials are needed, as electronic devices and circuits with constantly shrinking dimensions have to be manufactured. The tendency for critical-dimension miniaturization necessitates the use of electromagnetic radiation sources emitting to shorter wavelengths, or electron beam or ion beam sources. During the last few years, exposure systems emitting at the ultraviolet region, particularly at 248 nm or 193 nm, have been gradually employed and are principally used today in the semiconductor industry. In the next few years it is expected that exposure systems based on F₂ laser (157 nm) will be introduced, in order to continue dimension miniaturization, while in the near future the introduction of sources emitting at the 13 nm region is considered very possible.

However, the introduction of new lithographic exposure systems imposes the development of new polymeric lithographic materials suitable for the specific wavelength region employed. Intense research and development is taking place today for polymeric lithographic materials suitable for 157 nm exposures. However, the selection of suitable components for polymeric lithographic materials in this wavelength is particularly difficult, because most organic compounds present extremely high absorbance values (R. R Kunz, T. M. Bloomstein, D. E. Hardy, R. B. Goodman, D. K. Downs, J. E. Curtin, Proc. SPIE 1999, 3678, 13). A relative reduction of the absorbance values is achieved only in polymeric materials with significant content in C—F or Si—O bonds; hence research effort is mainly directed towards the development of materials rich in these two bond categories (R. Sooriyakumaran, D. Fenzel-Alexander, N. Fender, G. M. Waliraff, R. D. Allen, Proc. SPIE 2001, 4345, 319 και B. C. Trinque, T. Chiba, R. J. Hung, C. R. Chambers, M. J. Pinnow, B. P. Osburn, H. V. Tran, J. Wunderlich, Y. Hsieh, B. H. Thomas, G. Shafer, D. D. DesMarteau, W. Conley, C. G. Willson, J. Vac. Sci. Technol. B 2002, 20(2), 531).

In the case of Si—O rich polymeric materials, there is also extended literature concerning their application for lithography at other wavelengths. Usually, this application refers to negative tone materials (Q. Lin, A. Katnani, T. Brunner, C. DeWan, C. Fairchok, D. La Tulipe, J. Simons, K. Petrillo, K. Babich, D. Seeger, M. Angelopoulos, R. Sooriyakumaran, G. Wallraff, D. Hofer, Proc. SPIE 1998, 3333, 278); however, polymers that contain polyhedral oligomeric silsesquioxanes as components for etch resistance enhancement have been reported as positive tone materials for 193 nm lithography (H. Wu, Y. Hu, K. E. Gonsalves, M. J. Yacaman, J. Vac. Sci. Technol. B 2001, 19(3), 851). In this case the polyhedral oligomeric silsesquioxanes had exclusively cyclopentyl substituents.

For single layer lithography, the photosensitive polymeric materials (photoresist) films must have suitable absorbance (usually less than 0.5) to allow development in their whole thickness. However, in many cases at 157 nm and 13 nm, the photoresist film has much higher absorbance (e.g. photoresists based on aromatic, acrylic, and generally carbon polymers), that necessitates the photoresist thickness reduction below 100 nm. The problem is that such thin polymeric films cannot withstand the plasma etching step (following the lithography step); therefore pattern transfer is very difficult.

Bilayer lithography with a photoresist containing an inorganic element, which creates non volatile oxides, is proposed as an alternative solution. In bilayer lithography, the substrate is initially coated with a thick bottom polymer layer. On top of this layer, a thin photoresist film is coated, which is then exposed and wet developed. If the photoresist material contains an element that produces non volatile oxides (see for example M. Hatzakis, J. Paraszczak, J. Shaw, Proc. Microcircuit Engnrg. Lausanne, page 396, 1981 for organosilicon materials), the structure may then be dry-developed in oxygen plasma: The regions of the thick layer, covered with the organosilicon photoresist, are protected, while the other regions are etched away. The pattern is initially transferred through etching on the polymeric layer, before the substrate etching takes place. A significant requirement in such processes is that the surface and line edge roughness of the sample after dry development must be small.

### BRIEF DESCRIPTION OF THE INVENTION

The objective of this invention is to introduce a new class of lithographic materials based on new homopolymers and copolymers characterized by the presence of polyhedral oligomeric silsesquioxanes in their molecule. Among the known many classes of polyhedral oligomeric silsesquioxanes, the most promising ones are those possessing a cubic-octameric cage structure and a polymerizable or graftable pendant functional group Z (see scheme 1). The rest 7 substituents R are alkyl groups with up to 3 carbon atoms, and they are preferably ethyl groups. In the case of the copolymers, the polyhedral oligomeric silsesquioxanes are copolymerized with monomers preferably (meth)acrylates. At least one of the (meth)acrylates contains a hydrophilic group and at least one (meth)acrylate contains a protected hydrophilic group, which is deprotected after exposure to radiation. Methacrylic acid is an example of a monomer that contains a hydrophilic group. Tertiary butyl methacrylate is an example of a monomer that contains a protected hydrophilic group, which is deprotected after exposure to radiation. A characteristic copolymer, which contains polyhedral oligomeric silsesquioxane groups is illustrated in scheme 2.

Emphasis is placed on the application of the proposed materials for 157 nm, VUV and EUV lithography. The aim of this invention is also to provide materials that are suitable for single as well as bilayer lithography.

In addition, in the proposed materials the alkyl substituents of the polyhedral oligomeric silsesquioxanes that are not linked to the main chain (backbone) of the polymer, are ethyl groups or groups with similar size, namely groups with 1-3 carbon atoms, in order to reduce problems related to pattern transfer, roughness and high absorbance at 157 nm (such problems occur when the substituents are large alkyl groups such as cyclopentyl groups).

Scheme Captions

Scheme 1: A cubic-octameric cage structure polyhedral oligomeric silsesquioxane, having one polymerizable or graftable pendant functional group (Z). The rest 7 substituents (R) are alkyl groups.

Scheme 2: Characteristic copolymer containing polyhedral oligomeric silsesquioxane groups.

### APPLICATION EXAMPLES OF THE INVENTION

### HOMO- AND COPOLYMER SYNTHESIS EXAMPLES

The preparation of the polymers is carried out through free radical polymerization of individual monomers in the presence of the appropriate polymerization initiator (J. D. Lichtenhan, Y. A. Otonari, M. J. Carr, Macromolecules 1995, 28, 8435-8437). The synthesis takes place under nitrogen atmosphere and at 60° C. temperature. The monomers (totally 10 g) are dissolved in 30 ml of anhydrous and deaerated tetrahydrofuran (TBF), and then 0.01 g of 2,2′-azobis(isobutyronitrile) is added. The duration of the reaction ranges from 48 to 64 hours. The reaction mixture is added to methanol (1000 ml) in order to precipitate the polymer. The polymer is then dried under vacuum.

By applying the above experimental procedure homopolymers of 3-(3,5,7,9,11,13,15-Heptacyclopentylpentacyclo [9.5.1.1^{3,9}.1^{5,15}.1^{7,13}]octasiloxane-1-yl)propyl methacrylate(MethacrylCyclopentyl-POSS) and 3-(3,5,7,9,11,13,15-Heptaethylpentacyclo [9.5.1.1^{3,9}.1^{5,15}.1^{7,13}]octasiloxane-1-yl)propyl methacrylate (MethacrylEthyl-POSS) were prepared.

By applying the above experimental procedure copolymers of MethacrylCyclopentyl-POSS as well as of MethacrylEthyl-POSS with various monomers [tertiary butyl methacrylate (IBMA), methacrylic acid (MA), maleic anhydride (MAN), itaconic anhydride (IA), acrylic acid (AA) and α-(trifluoromethyl)acrylic acid (TAA)] were prepared. The % w/w composition (in the feed) is shown in table I.

### LITHOGRAPHIC EVALUATION EXAMPLES

### Example 1

A 5% w/w solution of the copolymer 7 in 1-methoxy-2-propanol (or in 4-methyl-2-pentanone) is prepared, by stirring at room temperature (25° C.). 5% w/w (relative to the copolymer) triphenylsulfonium hexafluoroantimonate is subsequently added as the photoacid generator. The solution is spin-coated on a silicon wafer at 3000 rpm. After baking for 3 minutes on hotplate at 160° C., the film thickness as measured by mechanical profilometer was 140 nm. Selected regions of the film were exposed to deep ultraviolet light using a Hg—Xe 500 W lamp and for various time intervals. Post-exposure bake followed at 120° C. for 2 minutes, and wet development by immersion in a 0.00135 N aqueous solution of tetramethylammonium hydroxide for 2 minutes and rinsing with deionized water. The exposed regions were dissolved at various rates depending on the exposure time, i.e. the polymeric film exhibited a positive tone behavior. The minimum dimension was 500 nm isolated lines (exposure time 100 sec). By a similar process, and with exposure of selected regions of the film to 157 nm radiation, positive tone behavior was observed.

TABLE I

| | MethacrylCyclopentyl- | MethacrylEthyl- | | | | | | |
|---|---|---|---|---|---|---|---|---|
| | POSS | POSS | TBMA | AA | TAA | MA | MAN | [symbol] |
| Homopolymer 1 | 100 | — | — | — | — | — | — | [symbol] |
| Homopolymer 2 | — | 100 | — | — | — | — | — | [symbol] |
| Copolymer 1 | 20 | — | 50 | — | 10 | 10 | — | [symbol] |
| Copolymer 2 | 40 | — | 30 | 10 | — | — | 20 | [symbol] |
| Copolymer 3 | — | 20 | 80 | — | — | — | — | [symbol] |
| Copolymer 4 | — | 30 | 60 | — | — | 10 | — | [symbol] |
| Copolymer 5 | — | 40 | 40 | — | — | 10 | — | [symbol] |
| Copolymer 6 | — | 60 | 20 | — | — | 20 | — | [symbol] |
| Copolymer 7 | — | 30 | 40 | — | — | 10 | — | [symbol] |

### Example 2

A 5% w/w solution of the copolymer 7 in 1-methoxy-2-propanol (or in 4-methyl-2-pentanone) is prepared, by stirring at room temperature (25° C.). 5% w/w (relative to the copolymer) triphenylsulfonium hexafluoroantimonate is then added as photoacid generator. The solution is spin-coated on a silicon wafer at 3000 rpm. After baking for 3 minutes on a hotplate at 160° C., the film thickness as measured by mechanical profilometer was 140 nm. Selected regions of the film were then exposed to a wide range of doses with 50 keV energy electron beam. Baking at 120° C. for 2 minutes and wet development followed as in example 1. Positive tone behavior was also observed. Regions exposed to doses higher than 100 μC/cm² were dissolved away during the development. Features smaller than 200 nm were resolved.

### Example 3

AZ 5214 (a commercial photoresist by Clariant) is coated on silicon wafers and then baked at 200° C. for 20 minutes. An insoluble 300 nm thick polymeric film is produced as a suitable bottom layer for bilayer lithography. On half of the above samples, a 5% w/w solution of the homopolymer 1 (see table I) in 4-methyl-2-pentanone was spin-coated at 3000 rpm. The solution had been prepared by stirring at room temperature (25° C.). Baking at 160° C. on a hotplate for 3 minutes followed, resulting in a top layer thickness equal to 115 nm. On the rest of the samples, a 5% w/w solution of the homopolymer 2 in 4-methyl-2-pentanone was spin-coated at 3000 rpm. The solution had been prepared by stirring at room temperature (25° C.). Baking at 160° C. on a hotplate for 3 minutes followed, resulting in a thickness equal to 110 nm. The etch rates of both materials were subsequently measured in an inductively coupled plasma (ICP) reactor (conditions: inductive power 600 W, bias voltage 100 V, electrode temperature 15° C.) in an oxygen plasma (flow: 100 sccm, pressure: 10 mTorr). The etch time ranged from 2 up to 15 minutes. Etching was monitored in situ by laser interferometry. On samples etched up to 2 minutes, negligible thickness loss was observed. On samples etched from 2 up to 15 minutes, minimal thickness loss was observed. The thickness loss was lower for homopolymer 2 (MethacrylEthyl-POSS) samples. Thickness loss was also measured by mechanical profilometer. Given that the time required to etch the AZ 5214 layer is one minute, it is concluded that the top layers of homopolymers 1 and 2 successfully protect the bottom AZ 5214 layer. Therefore, they can be used for bilayer lithography. These samples were then observed in an atomic force microscope (AFM). For homopolymer 1 the rms roughness was 14.8 nm, while in the case of homopolymer 2 roughness was less than 1 nm. It was concluded that homopolymer 2 (MethacryIEthyl-POSS) provides smoother films after plasma treatment and is more resistant in the plasma, therefore it is the most suitable POSS-homopolymer for high resolution bilayer lithography.

### Example 4

Samples with AZ 5214 substrate were prepared according to previous example 3. In each sample a copolymer film was coated. The copolymers contained different amount in MethacrylEthyl-POSS monomers (copolymers 3, 4, 5, 6 and 7 of table 1).

Etching was monitored by laser interferometry, as described the previous example. It was found that samples having as top layer a copolymer, prepared from monomers that had 30% or higher MethacrylEthyl-POSS w/w content, presented negligible thickness loss for etching times up to 10 minutes. Given that the time required to etch the AZ 5214 layer is one minute, it was concluded that the top layers of copolymers, prepared from monomers that had 30% or higher MethacrylEthyl-POSS w/w content, successfully protect the bottom AZ 5214 layer. Thus, a monomer mixture with at least 30% w/w MethacrylEthyl-POSS produces copolymers with sufficient etch resistance for bilayer lithography. Furthermore, surface roughness measurements by AFM gave roughness less than 1 nm.

We claim:

1. A lithographic material that contains a polymer bearing at least one polyhedral oligomeric silsesquioxane group, the alkyl substituents of the group—that are not linked to the main chain (backbone) of the polymer—containing up to 3 carbon atoms.

2. A positive tone lithographic material that contains a polymer bearing at least one polyhedral oligomeric silsesquioxane group, the alkyl substituents of the group—that are not linked to the main chain (backbone) of the polymer—containing up to 3 carbon atoms.

3. A chemically amplified positive tone lithographic material that contains a polymer bearing at least one polyhedral oligomeric silsesquioxane group, the alkyl substituents of the group—that are not linked to the main chain (backbone) of the polymer—containing up to 3 carbon atoms.

4. A chemically amplified positive tone lithographic material that contains a polymer bearing at least one polyhedral oligomeric silsesquioxane group, the alkyl substituents of the group—that are not linked to the main chain (backbone) of the polymer—being ethyl groups.

5. A chemically amplified positive tone lithographic material that contains a (meth)acrylic polymer, bearing at least one polyhedral oligomeric silsesquioxane group, the alkyl substituents of the group—that are not linked to the main chain (backbone) of the polymer—being ethyl groups.

6. A lithographic process including a 157 nm exposure of a lithographic material containing a polymer, bearing at least one polyhedral oligomeric silsesquioxane group.

7. A lithographic process including a 157 nm exposure, or generally VUV, or EUV exposure, of a lithographic material containing a polymer, bearing at least one polyhedral oligomeric silsesquioxane group, the alkyl substituents of the group—that are not linked to the main chain (backbone) of the polymer—containing up to 3 carbon atoms.

8. A lithographic process including a 157 nm exposure, or generally VUV, or EWV exposure, of a lithographic material containing a polymer, bearing at least one polyhedral oligomeric silsesquioxane group, the alkyl substituents of the group—that are not linked to the main chain (backbone) of the polymer—being ethyl groups.

9. A bilayer lithographic process with a positive tone lithographic material containing a polymer, bearing at least one polyhedral oligomeric silsesquioxane group, the alkyl substituents—that are not linked to the main chain (backbone) of the polymer—containing up to 3 carbon atoms.

10. A bilayer lithographic process with a positive tone lithographic material containing a polymer, bearing at least one polyhedral oligomeric silsesquioxane group, the alkyl substituents—that are not linked to the main chain (backbone) of the polymer—being ethyl groups.
